(19) United States
(12) Patent Application Publication
(10) Pub. No.: US 2006/0259674 A1
(43) Pub. Date: Nov. 16, 2006

(54) Apparatus and method for granting access to a hardware interface shared between multiple software entities

(76) Inventors: Robert Dunstan, Forest Grove, OR (US); Steven L. Grobman, El Dorado Hills, CA (US); David I. Poisner, Folsom, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/128,934

(22) Filed: May 12, 2005

(51) Int. Cl. G06F 13/14

(52) U.S. Cl. 710/240

(57) ABSTRACT

A method and apparatus for granting access to a hardware interface shared between multiple software drivers are described. In one embodiment, the apparatus includes an interface to provide access to a hardware function or a resource. As described herein, the hardware function or resource is shared between at least two software entities, such as, for example, device drivers. In one embodiment, access verification logic denies an access request for the hardware function, unless the key associated with the access request matches a stored key semaphore. In one embodiment, a key size may be relatively large to provide a very low probability that a malicious software entity could accidentally or maliciously gain access to the software. Other embodiments are described and claimed.

### FIELD

One or more embodiments relate generally to the field of integrated circuit and computer system design. More particularly, one or more of the embodiments relate to a method and apparatus for granting access to a hardware interface shared between multiple software entities.

### BACKGROUND

There are cases where it is desirable to allow two or more software entities to share access to a single hardware function. There are several generally known methods to accomplish the sharing of access to a single hardware function between multiple software entities. One technique involves an additional software entity that is added to provide arbitration and serialization of the accesses to the hardware. Another technique requires the one or more software entities, which share access to the single hardware function, to directly negotiate between one another to establish temporary ownership of the hardware function. Unfortunately, these two approaches are not viable for many cases due to software restrictions. As a result of such a software restriction, either new software is required or modification of the software is required to enable detection of the software entities.

A third approach provides sharing of the single hardware function by providing a hardware arbitration element. In accordance with such a technique, the software entities each directly access the hardware arbitration element and abide by the value as reported by that arbitration element. Unfortunately, this approach also has several limitations. Typically, this approach involves setting hardware semaphores based on a CPU read or write cycle.

As described herein, a semaphore refers to a hardware or software flag that provides a variable with a value that indicates the status of a common resource. Typically, a semaphore is a value in a designated place that each software entity or process can check and then change. Depending on the value that is found, the process or software entity can use the resource or will find that the resource is in use and wait for some period of time.

Unfortunately, the use of such an arbitration semaphore can fail if one of the software entities accidentally or maliciously fails to respect the arbitration semaphore. Specifically, the ability of the device to change the arbitration semaphore may enable a device to maliciously access the hardware resource or function. In other words, traditional arbitration semaphores are easily circumvented, allowing malicious software to, for example, gain access to protected content or perform other undesirable activities.

### BRIEF DESCRIPTION OF THE DRAWINGS

The various embodiments of the present invention are illustrated by way of example, and not by way of limitation, in the figures of the accompanying drawings and in which:

FIG. 1 is a block diagram illustrating a computer system, including a hardware device having an interface, which is shared between multiple software entities, in accordance with one embodiment.

FIG. 2 is a block diagram further illustrating the hardware interface, as shown in FIG. 1, in accordance with one embodiment.

FIG. 3 is flowchart illustrating a method sharing access of a hardware interface between at least two software entities, in accordance with one embodiment.

FIG. 4 is a flowchart illustrating a method for issuing a keyed semaphore to a software entity for access to a hardware interface shared between the software entity and at least one other software driver, in accordance with one embodiment.

FIG. 5 is a flowchart illustrating a method for decryption of received encrypted commands issued by a software entity, in accordance with one embodiment.

FIG. 6 is a flowchart illustrating a method for assigning a keyed semaphore to a software entity to grant access to a hardware interface to receive some hardware function, wherein the hardware interface is shared between multiple software drivers, in accordance with one embodiment.

FIG. 7 is a flowchart for regulating ownership of a shared hardware interface by invalidating the keyed semaphore assigned for ownership of the hardware interface after a predetermined period of time, in accordance with one embodiment.

FIG. 8 is a flowchart illustrating a method for issuing a key request to a hardware interface shared between multiple device drivers to establish temporary, exclusive ownership of the hardware interface, in accordance with one embodiment.

FIG. 9 is a flowchart for encrypting commands transmitted to a shared hardware interface using a keyed semaphore, in accordance with one embodiment.

FIG. 10 is a flowchart illustrating a method for sharing access of a hardware interface between at least two software entities assigned partial ownership of a hardware function, in accordance with one embodiment.

FIG. 11 is a computer system, including at least one hardware interface that is shared between multiple device drivers, in accordance with one embodiment.

FIG. 12 is a block diagram illustrating various design representations or formats for simulation, emulation and fabrication of a design using the disclosed techniques.

### DETAILED DESCRIPTION

A method and apparatus for granting access to a hardware interface shared between multiple software entities are described. In one embodiment, the apparatus includes an interface to provide access to a hardware function or a resource. As described herein, the hardware function or resource is shared between at least two software entities, such as, for example, device drivers. In one embodiment, access verification logic denies an access request for the hardware function, unless a key associated with the access request matches a stored key semaphore. In one embodiment, a key size may be relatively large to reduce the probability that a malicious software entity could accidentally or maliciously gain access to the software.

In the following description, numerous specific details such as logic implementations, sizes and names of signals and buses, types and interrelationships of system components, and logic partitioning/integration choices are set forth in order to provide a more thorough understanding. It will be appreciated, however, by one skilled in the art that the invention may be practiced without such specific details. In other instances, control structures and gate level circuits have not been shown in detail to avoid obscuring the invention. Those of ordinary skill in the art, with the included descriptions, will be able to implement appropriate logic circuits without undue experimentation.

In the following description, certain terminology is used to describe features of the invention. For example, the term “logic” is representative of hardware and/or software configured to perform one or more functions. For instance, examples of “hardware” include, but are not limited or restricted to, an integrated circuit, a finite state machine or even combinatorial logic. The integrated circuit may take the form of a processor such as a microprocessor, application specific integrated circuit, a digital signal processor, a micro-controller, or the like.

System

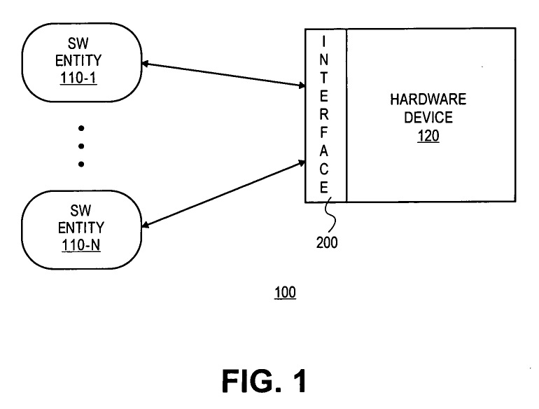

FIG. 1 illustrates a computer system 100, including a hardware device 120 having a hardware interface 200 that is shared between multiple software entities 110 (110-1, . . . , 110-N). In one embodiment, hardware device 120 is described in the context of a disk drive. However, a hardware device, as described herein, may include and is not limited to host controllers, such as a serial advance technology attachment (SATA) host controller, a local area network (LAN) host controller, an audio host controller, a graphics host controller or other like controller or device having an interface, which is shared between multiple software entities. As described herein, the term “software entity” may include, but is not limited to, device drivers, control software or other like modules that provide control of a peripheral device, input/output (I/O) device or other like component of a computer system.

As shown in FIG. 1, hardware interface 200 allows the selected SW entity 110 to take exclusive ownership of hardware interface 200 to issue commands to hardware device 120 and keep all other software entities from accessing hardware device 120. As described herein, the term “hardware resource” or “hardware function” includes, but is not limited to, some functionality or resource provided by a hardware device, such as, for example, disk storage, network access, and I/O access for audio, video, graphics or the like. In one embodiment, hardware interface 200, in addition to including logic for enabling sharing of hardware interface 200 between SW entities 110 is defined as a set of registers used to access some hardware function/resource provided by hardware device 120.

In an alternative embodiment, ownership of hardware interface 200 to issue commands to hardware device 120 is limited to a predetermined portion of the hardware resource. For example, in one embodiment, hardware resource device 120 is, for example, a hard disk. In accordance with such an embodiment, ownership of hardware interface 200 limits the selected software entity 110 to a portion of the hard disk drive and not the entire disk. Accordingly, in one embodiment, a hardware resource or hardware function may be shared between multiple software entities, such that each software entity is assigned a sub-range within the specific hardware resource or hardware function, referred to herein as “partial ownership” of a hardware resource or function as contrasted with exclusive ownership of a hardware resource or hardware function, which enables access to the entire range hardware resource or hardware function.

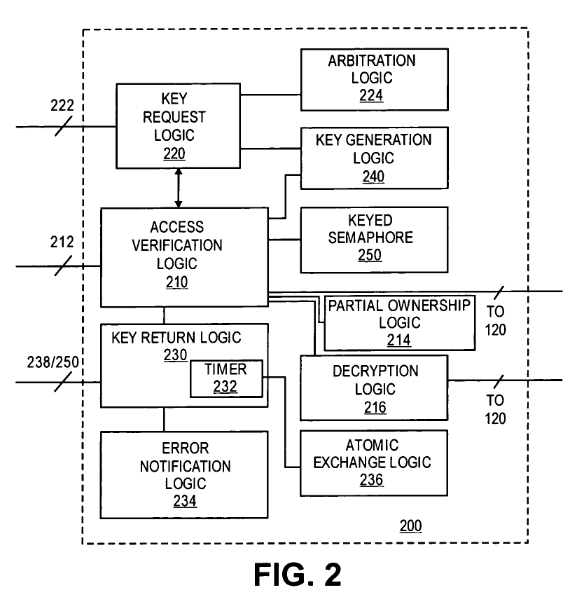

As shown in FIG. 2, interface 200 includes logic required to grant exclusive ownership of a hardware interface to issue commands or to access a hardware function, in accordance with one embodiment. As shown in FIG. 2, interface 200 may include access verification logic 210. In one embodiment, access verification logic 210 receives an access request 212 for a hardware function from one of at least two software entities, which share access to hardware interface 200. In one embodiment, access verification logic 210 grants an access request 212 issued by a software entity if a key associated with the access request 212 matches a stored, keyed semaphore 250. As described herein, a “keyed semaphore” or “key” may refer to a hardware or software flag to indicate ownership of a hardware interface shared between multiple software entities. In one embodiment, the keyed semaphore 250 is a 64-bit random integer, such as, for example, a 64-bit random number.

As further illustrated in FIG. 2, hardware interface may include partial ownership logic 214, in accordance with one embodiment. Representatively, partial ownership logic 214 may be used to track a sub-range of the hardware resource or hardware function assigned to each software entity that shares access to the hardware resource or hardware function. In accordance with this embodiment, once access verification logic 210 grants ownership to a selected software entity to issue commands to the hardware resource or hardware function, access verification logic 210, in conjunction with partial ownership logic 214 ensures that access to the hardware resource or function is limited to the sub-range of the hardware resource or hardware function assigned to the selected software entity granted partial ownership of the hardware resource or hardware function.

Although illustrated with reference to FIG. 2, it should be recognized that partial ownership logic 214 may be omitted from embodiments which function according to exclusive ownership of the hardware resource or hardware function, wherein access to the hardware resource or hardware function by the selected software entity is not limited to an assigned sub-range of the device or function. In one embodiment, partial ownership logic 214 simply denies access requests outside sub-range of hardware devices assigned to a software entity awarded partial ownership. In an alternative embodiment, partial ownership logic 214, in combination with error notification logic 234, may issue an error notification when a selected software entity awarded partial ownership attempts to access the hardware resource or function outside an assigned sub-range.

In one embodiment, hardware interface 200 includes key request logic 220. In one embodiment, key request logic 220 provides a keyed semaphore to a software entity in response to a received key request 222. In one embodiment, key request logic 220 provides keyed semaphore 250 by storing the keyed semaphore within a register accessible by the software entity, such as software entity 110-1, as shown in FIG. 1. In an alternative embodiment, key request logic 220 writes keyed semaphore 250 directly to memory, such as a memory buffer owned by the software entity 110-1.

In one embodiment, key request logic 220 uses arbitration logic 224 to select a software entity when multiple software entities simultaneously submit key requests 222 to key request logic 220. In one embodiment, key generation logic 240 generates an N-bit keyed semaphore, wherein N is an integer greater than one, such as, for example, 64-bits. In one embodiment, key generation logic 240 may include a random number generator or provide other conventional means for generation of an N-bit keyed semaphore.

In one embodiment, a random number generator is used to generate an N bit integer value greater than zero, such as, for example, a 64-bit random number as the keyed semaphore. In one embodiment, for a key size of 64-bits, the probability of “guessing” the key could be a low as 1:2⁶⁴. Accordingly, if the key size is sufficiently large, there is a very low probability that a malicious software entity or rogue agent could accidentally or maliciously gain access to the hardware function by “guessing” a value of keyed semaphore 250.

As shown in FIG. 2, access verification logic 210 of hardware interface 200 provides a mechanism whereby shared hardware interface 200 ignores subsequent commands or access requests issued by a software entity unless the software entity can prove that the software entity possesses a key. In one embodiment, the software entity presents that key as part of an access request, referred to herein as an “atomic access operation” or in association with one or more issued commands. Conversely, as described herein, any access request or issued commands having an associated invalid key are identified as an “unauthorized access attempt” and ignored.

In one embodiment, hardware interface 200 includes key return logic 230. In one embodiment, key return logic 230 provides a mechanism for a software entity that has previously received a keyed semaphore to return the key to relinquish exclusive ownership of hardware interface 200. In one embodiment, returning of a stored key semaphore 250 allows another software entity to request another key to establish ownership of hardware interface 200. In one embodiment, key return logic 230 includes timer 232, which keeps track of an amount of time since a keyed semaphore 250 was issued to a selected software entity. In accordance with one embodiment, key return logic 230 invalidates keyed semaphore 250 once timer 232 has reached a predetermined period of time or expired. As described herein, a key that has been relinquished is no longer considered valid.

As further illustrated in FIG. 2, hardware interface 200, in one embodiment, includes atomic exchange logic 236. In one embodiment, atomic exchange logic 236 operates in conjunction with key return logic 230 in response to a received atomic exchange request 238. As described herein, an “atomic exchange request” is issued by a software entity having current ownership of the hardware interface to maintain ownership of hardware interface 200. In one embodiment, receipt of an atomic exchange request 238 by atomic exchange logic 236 causes atomic exchange logic 236 to reset timer 232 to allow the selected software entity continued software access for issuing of instructions to a hardware device via hardware interface 200.

In one embodiment, in response to receipt of an atomic exchange request 238, atomic exchange logic 236 may invalidate the keyed semaphore received with the atomic exchange request and issue a new keyed semaphore to the software entity with a reset timer. In one embodiment, the invalidation of the key received with the atomic exchange request and issuance of a new key are performed within the context of a single operation, to prohibit another software entity from gaining access to the hardware resource/function during the atomic exchange request. Accordingly, the new keyed semaphore allows the software entity continued ownership of hardware interface 200 for continued issuance of commands or access to a hardware device 120. In one embodiment, access verification logic 210 may reset timer 232 with a predetermined value for each atomic access to hardware device 120 using the keyed semaphore.

In one embodiment, error notification logic 234 can generate a notification or set an error status when there is an “unauthorized access attempt,” referred to herein as an issued command or access request that has an associated key, which has been invalidated or simply does not match stored key semaphore 250. In one embodiment, a software entity issues commands to a hardware device or hardware function by encrypting the commands using the keyed semaphore assigned to the software entity as part of the key request. In one embodiment, the key semaphore is also encrypted and provided with the commands issued to the hardware interface. Correspondingly, hardware interface 200 includes decryption logic 216 to decrypt commands using the stored keyed semaphore 250 and provides the decrypted commands to the hardware device or function. In one embodiment, a key associated with the received encrypted commands is validated to issuance of the decrypted commands to the hardware device or function.

In the embodiments described, the use of a keyed semaphore facilitates the sharing of a hardware device, including a hardware resource or hardware function by multiple software entities. Hence, the use of the keyed semaphore enables software entities to establish exclusive ownership of a hardware resource or hardware function. In an alternative embodiment, a software entity establishes partial ownership of a hardware resource or hardware function. In accordance with such an embodiment, partial ownership of the hardware resource or hardware function limits ownership to a sub-range within the specific hardware resource or hardware function. Procedural methods for implementing embodiments indicated above are now described.

Operation

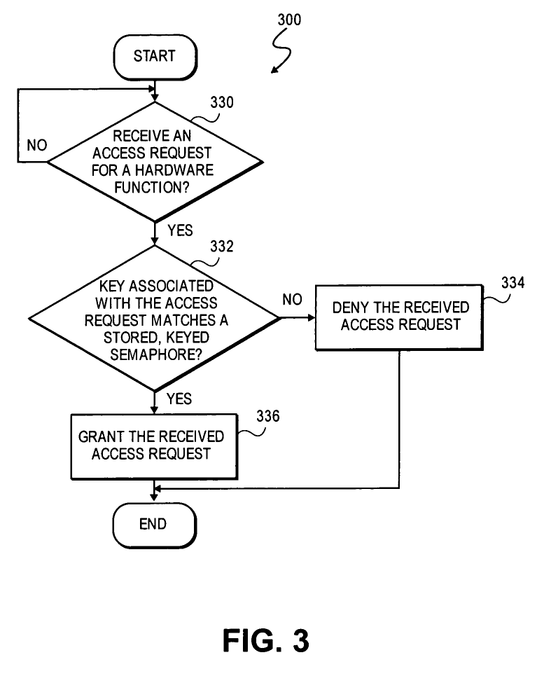

FIG. 3 is a flowchart illustrating a method 300 for controlling access and ownership of a hardware interface to issue commands or access a hardware device or function, in accordance with one embodiment. At process block 330, it is determined whether an access request is received for a hardware function. If an access request for the hardware function is received, at process block 332, it is determined whether a key associated with the access request matches a stored keyed semaphore. In the embodiments described, the associated key may be provided in conjunction with the access request, a command or the like. In one embodiment, the key may be used to encrypt such information and provide the encrypted information to the hardware interface of a hardware function or device, which then uses a stored keyed semaphore to decrypt the information.

Referring again to FIG. 3, if the key associated with the access request matches a stored keyed semaphore, at process block 336, a software entity that issued the access request is granted access to the hardware function or device at process block 336. Otherwise, at process block 334, the access request is denied. In one embodiment, denial of the access request may result in the generation of a notification or setting of an error status in response to an unauthorized access attempt, which may be issued to a user, a system administrator or the like, using, for example, error notification logic 234 shown in FIG. 2.

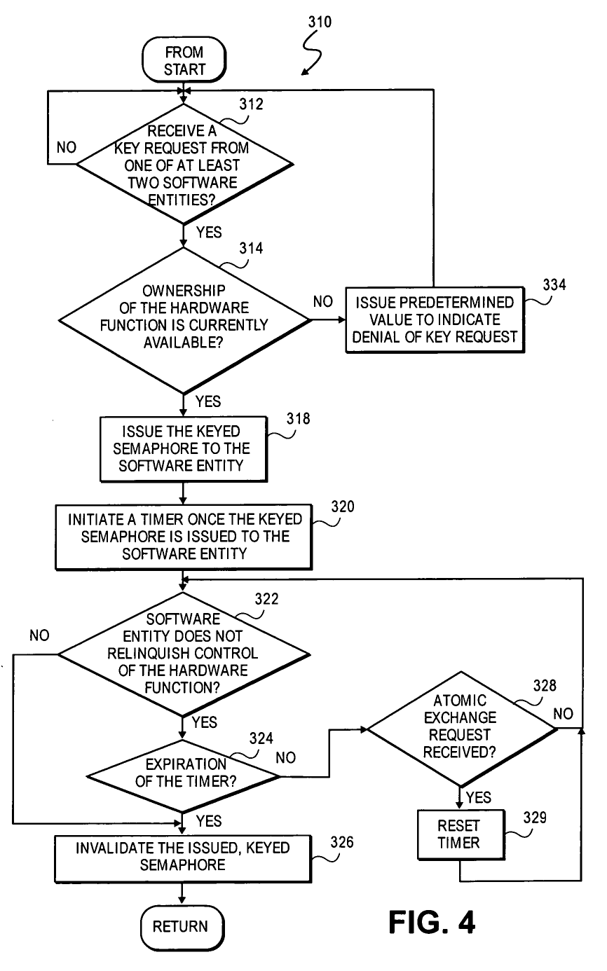

FIG. 4 is a flowchart illustrating a method 310 for issuing a keyed semaphore to a selected software entity in response to a received key request, in accordance with one embodiment. At process block 312, it is determined whether a key request is received from at least one software entity. Once received, at process block 314, it is determined whether ownership of a hardware function or device is currently available. In one embodiment, ownership of the hardware function is available if a keyed semaphore generated for establishing ownership of the device is unassigned. In one embodiment, the keyed semaphore is unassigned when a previous keyed semaphore has been cleared.

In one embodiment, the unavailability of a keyed semaphore indicates that ownership to the hardware function is currently assigned to a software entity or device driver, which shares the hardware function or device, for example, as shown in FIG. 1. As shown at process block 316, when ownership of the hardware device is currently unavailable, a predetermined value is issued to the software entity to indicate denial of the key request issued by software entity. Accordingly, in one embodiment, when a software entity wants to gain ownership of the hardware, a key request 222 is issued to key request logic 220 of hardware interface 200, as shown in FIG. 2.

As described herein, the key returned by a hardware interface may be a zero or other predefined value that indicates to the software entity that ownership of the hardware function is currently unavailable. Conversely, in one embodiment, if the keyed semaphore received in response to the key request is a non-zero value, the software entity determines that the software entity is granted ownership of the hardware function and may use the key to issue commands or to perform atomic access of the hardware device.

Accordingly, at process block 318, the keyed semaphore is issued to the software entity. In one embodiment, a time-out mechanism is provided at process block 320 in which a timer is initiated once the keyed semaphore is issued to the software entity. In one embodiment, the time-out mechanism provided by the hardware interface provides a mechanism to automatically invalidate an issued keyed semaphore after a specific amount of time has passed, for example, as performed by key return logic 230, as shown in FIG. 2.

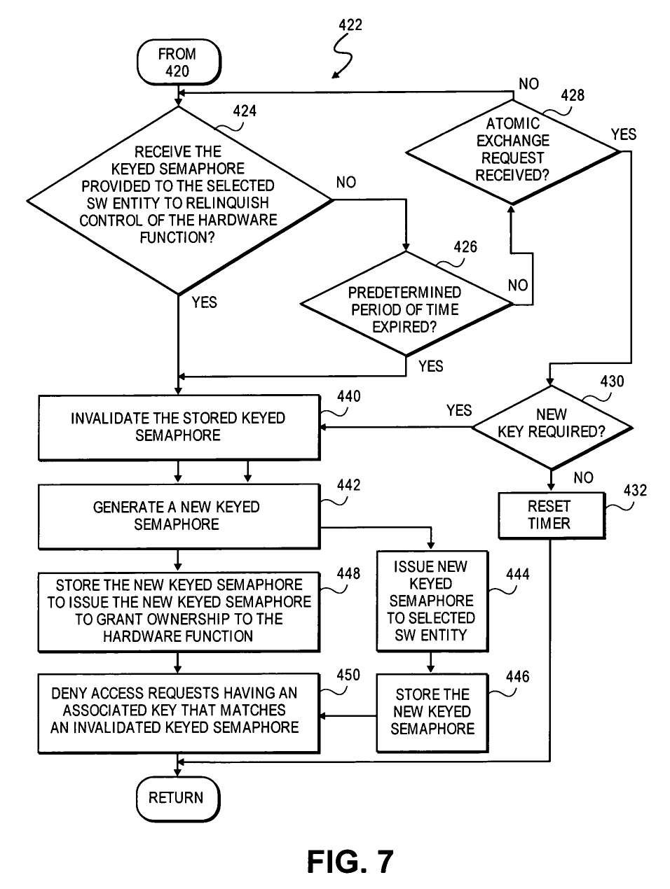

Accordingly, at process block 322, it is determined whether the software entity assigned ownership of the hardware interface has relinquished control of the hardware interface or function. If the software has relinquished control of the hardware function, process block 326 is performed. Otherwise, at process block 324, it is determined whether the timer has expired. In one embodiment, if the timer has not expired at process block 324, at process block 328, it is determined whether an atomic exchange request is received from the software entity. In one embodiment, a received atomic exchange request, for example, by atomic exchange logic 236 of FIG. 2, may require issuance of a new key, for example, as shown in FIG. 7, described below.

Accordingly, in one embodiment, an atomic exchange request provides a software entity with a guarantee of continued ownership of a hardware interface if the atomic exchange request is issued prior to expiration of the keyed semaphore. However, if the timer expires prior to receipt of an atomic exchange request, at process block 326, the keyed semaphore is invalidated. In one embodiment, an invalidated keyed semaphore, received in conjunction with an access request, results in a denial of the access request and issuing of a notification or error status for the detected unauthorized access attempt.

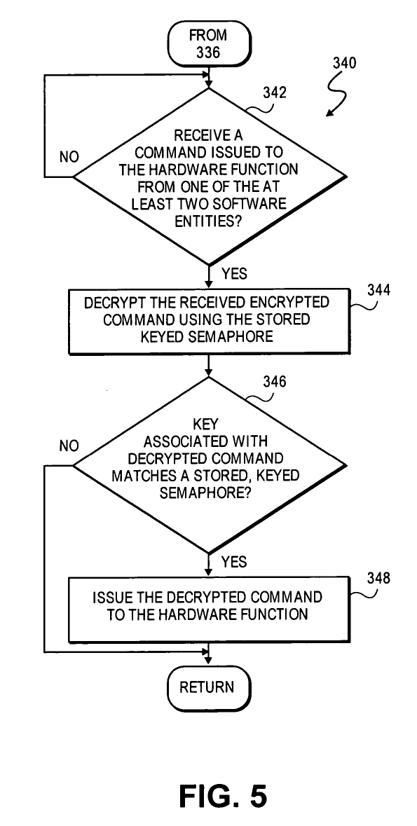

FIG. 5 is a flowchart illustrating a method 340 for decrypting an encrypted command received from a software entity granted temporary exclusive ownership of the hardware function shared between multiple software entities, in accordance with one embodiment. At process block 342, it is determined whether a command is issued to the hardware function from one of at least two software entities. Once a command is received, at process block 344, the command is decrypted using the stored keyed semaphore.

Details regarding encryption and decryption of software commands or access requests issued by a software entity to a hardware interface are omitted to avoid obscuring details of the invention. Accordingly, encryption and decryption, using the keyed semaphore, may be performed using conventional techniques while remaining within the scope of the described embodiments.

In one embodiment, as illustrated by process block 346, it is determined whether a key associated with the decrypted command matches a stored, keyed semaphore. If the key associated with the decrypted command matches the stored, keyed semaphore, process block 348 is performed. Accordingly, in one embodiment, an encrypted message, which may include encrypted commands issued by a software entity to the hardware device or function, includes a keyed semaphore to validate to the hardware interface that a received command is valid.

Accordingly, in one embodiment, a decrypted key is provided with the encrypted commands. However, in an alternative embodiment, the key is encrypted along with the issued command and provided as an encrypted message to the hardware interface. In the embodiment shown in FIG. 2, hardware interface 200 may use, for example, decryption logic 216 in combination with access verification logic 210 to decrypt the received message and ensure that a decrypted key contained within the encrypted message matches a stored, keyed semaphore 250. At process block 348, the decrypted command is issued to the hardware function.

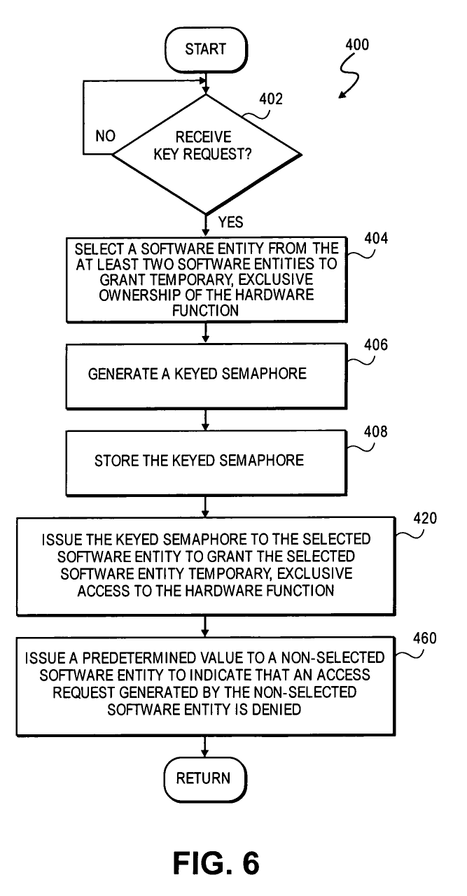

FIG. 6 is a flowchart illustrating a method 400 for assigning a keyed semaphore to issue temporary, exclusive ownership of a hardware interface to issue commands or access a hardware function, in accordance with one embodiment. At process block 402, it is determined whether an access request is received. Once received, at process block 404, a software entity is selected from at least two software entities that share access to a hardware function. In one embodiment, the selected software entity is granted temporary, exclusive access to the hardware function to access or issue commands to the hardware function.

In one embodiment, as shown in FIG. 2, a hardware interface 200 includes arbitration logic 224 to select a software entity to award temporary hardware ownership if simultaneous key requests are received from software entities that share access to a hardware function. Once selected, at process block 406, a keyed semaphore is generated using, for example, a random number generator to provide a 64-bit random integer as a keyed semaphore. At process block 408, the keyed semaphore is stored within some storage accessible by a hardware interface, such as one or more registers or a memory location in which the hardware interface has access.

In one embodiment, at process block 420, the keyed semaphore is issued to the selected software entity to indicate that the selected software entity is granted temporary exclusive access to the hardware function. However, for the remaining software entities, at process block 440, a predetermined value is issued to the non-selected software entities to indicate that the access, or key request, issued by the non-selected software entity is denied. In one embodiment, the predetermined value is a zero value, whereas a keyed semaphore that is a non-zero value may indicate the granting of temporary exclusive access to a hardware function or device.

FIG. 7 is a flowchart illustrating a method 422 for relinquishing of a keyed semaphore to relinquish ownership of a hardware function and invalidation of a keyed semaphore if the keyed semaphore is not relinquished within a predetermined period of time, according to one embodiment. At process block 424, it is determined whether a keyed semaphore is received from a selected software entity to relinquish control of a hardware function. If the keyed semaphore is received, process block 428 is performed. Otherwise, at process block 426, it is determined whether a predetermined period of time is expired, for example, since the keyed semaphore was issued to a selected software entity. At process block 428, it is determined whether an atomic exchange request is received.

As described with reference to FIG. 2, in one embodiment, an atomic exchange request 238 received by key return logic 230 is provided to atomic exchange logic 236. In one embodiment, an atomic exchange request 238 may require issuance of a new keyed semaphore 250 to a software entity. In an alternative embodiment, the atomic exchange request 238 may simply request resetting of the timer to once again set the timer with the predetermined value to provide a selected software entity with continued ownership of a hardware interface for continued atomic access or issuance of commands to a hardware function.

Referring again to FIG. 7, at process block 430, it is determined whether the atomic exchange request requires a new key. If a new key is not required, at process block 432, the timer is reset with a predetermined value to allow the selected software entity with continued ownership of the hardware interface for continued atomic access or issuance of commands to the hardware function. Otherwise, if a new key is required, process blocks 440 and 442 are performed to invalidate the keyed semaphore and generate a new keyed semaphore. Once the new keyed semaphore is generated, at process block 444, the new keyed semaphore is issued to the software entity to provide the software entity with continued ownership of the hardware interface for atomic access or issuance of commands to the hardware function. Once issued, at process block 446, the new keyed semaphore is stored and control flow branches to process block 450, as described below.

In one embodiment, once the keyed semaphore is relinquished by the software entity, or the predetermined period of time expires, a new keyed semaphore is generated at process block 430. At process block 432, the new keyed semaphore is stored to enable issuing of the new keyed semaphore to grant subsequent ownership of the hardware function. At process block 428, once either the predetermined period of time is expired or the software entity has relinquished control of the keyed semaphore by providing the keyed semaphore to the hardware interface, the keyed semaphore is invalidated. As described herein, invalidation of a keyed semaphore, in association with an access request, may result in denial of the access request and possibly setting a notification or error status as a result of the unauthorized access attempt.

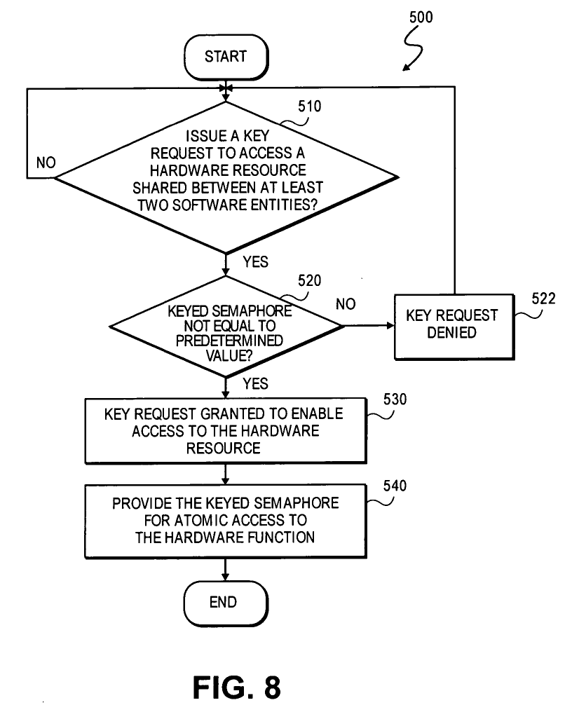

FIG. 8 is a flowchart illustrating a method 500 performed by a software entity to receive keyed semaphore to establish temporary ownership of a hardware interface and function shared between multiple software entities, in accordance with one embodiment. At process block 510, it is determined whether an access request is issued to access a hardware function or resource shared between multiple software entities. As described herein, the requested or keyed semaphore is referred to as a “key request.” At process block 520, it is determined whether a keyed semaphore, received in response to the key request, is not equal to some predetermined value. When a received keyed semaphore is not equal to the predetermined value, a software entity that received the keyed semaphore establishes temporary exclusive ownership of the hardware interface to issue commands and access the hardware function. Accordingly, at process block 540, the software entity provides the keyed semaphore in connection with commands issued to the hardware function to perform atomic access of the hardware function.

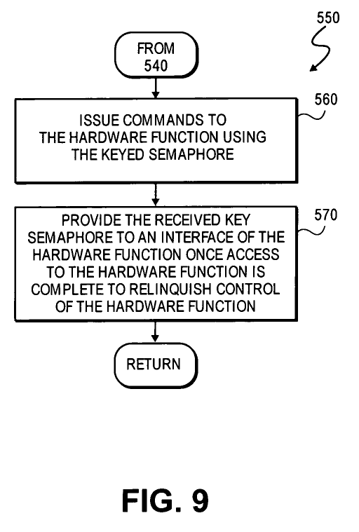

FIG. 9 is a flowchart illustrating a method for providing the keyed semaphore of process block 540, in accordance with one embodiment. At process block 560, commands issued to the hardware function are issued using the keyed semaphore. Once the selected software entity has completed access, or issuing of operations to a hardware function, at process block 570, the software entity returns the received keyed semaphore to an interface of the hardware function to relinquish control of the hardware function.

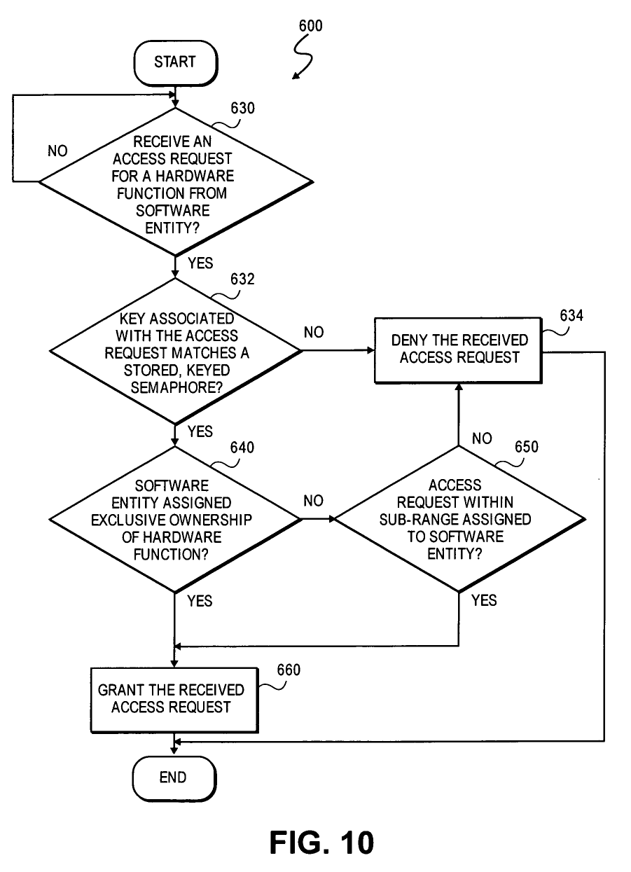

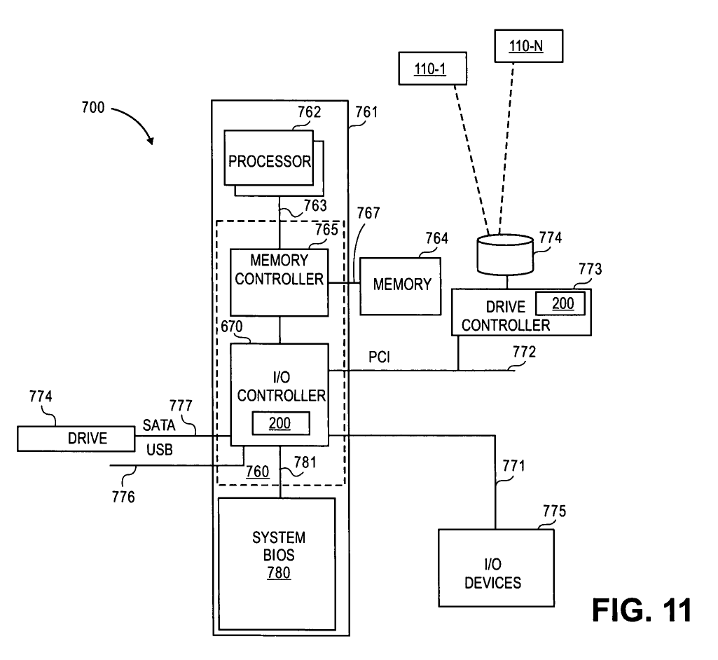

FIG. 10 is a flowchart illustrating a method 600 for granting access to a hardware interface shared between multiple software entities assigned partial ownership of a hardware function. In one embodiment, the hardware function is, for example, a hard disk, such as hard disk 774, as shown in FIG. 11. In accordance with such an embodiment, the software entities, such as, for example, disk drivers 110, as shown in FIG. 11, are each assigned a respective sub-range of hard disk 774. In accordance with this embodiment, additional security may be provided by limiting software entities that share a hardware resource or function to an assigned sub-range of the hardware resource or function.

Referring again to FIG. 10, at process block 630, it is determined whether an access request is received for a hardware function. If an access request for the hardware function is received, at process block 632, it is determined whether a key associated with the access request matches a keyed semaphore. In the embodiments described, the associated key may be provided in conjunction with the access request, the command or the like. In one embodiment, the key may be used to encrypt such information and provide the encrypted information to the hardware interface of a hardware function or device, which then uses a stored keyed semaphore to decrypt the information.

Referring again to FIG. 10, if the key associated with the access request matches a keyed semaphore, at process block 640, it is determined whether a software entity that issued the access request is assigned exclusive ownership of the hardware function or device. If the software entity is assigned exclusive ownership of the hardware function or device, at process block 660, the received access request for the hardware function or device is granted. Otherwise, it is determined that the software entity that issued the access request is limited to partial ownership of the hardware function or device.

Accordingly, at process block 650, it is determined whether the access request falls within a sub-range of the hardware device/function assigned to the software entity. If the access request falls within the sub-range assigned to the software entity, at process block 660, the access request is granted. Otherwise, at process block 634, the access request is denied. In one embodiment, denial of the access request may result in the generation of a notification or setting of an error status in response to an unauthorized access attempt, which may be issued to a user, a system administrator, or the like, using, for example, error notification logic 234, as shown in FIG. 2.

FIG. 11 is a block diagram illustrating a computer system 700 in which the hardware interface logic 200, as described in the embodiments herein, may be implemented. Initially, the software entities 110 (110-1, . . . , 110-N) and other like components are stored within the hard disk or disk memory 774, as shown in the computer system 700 of FIG. 5. In one embodiment, an operating system (OS) loads device driver software entities 110 for operation.

Representatively, computer system 700 may be, for example, a personal computer system. Computer system 700 may include one or more processors (e.g., processor 762), a memory controller 765, an input/output (I/O) controller 770, and one or more BIOS memories (e.g., BIOS memory 780). In one embodiment, processor 762, memory controller 765, I/O controller 770 and BIOS memory 780 may reside on a motherboard 761. In an alternative embodiment, one or more of processor 762, memory controller 765, I/O controller 770 and BIOS memory 780 may reside on other types of component boards, for example, chipset 760.

Representatively, computer system 700 may comprise a processor system interconnect (front-side bus (FSB)) 763 for communicating information between host processor 762 and a chipset 760. As described herein, the term “chipset” is used to described collectively, the various devices coupled to processor 762 to perform desired system functionality. As described herein, the term “interconnect” is defined to include a point-to-point interconnection between devices, including a multi-drop bus where more than two chips are joined to the same semiconductor or other like interconnect for enabling communication between the various devices and components on a motherboard.

In one embodiment, chipset 760 may include a memory controller 765 for enabling read-access and write-access from main memory 764, which is coupled to chipset 760 via interconnect 767. As described herein, main memory 764 refers to both volatile random access memory (RAM), in which data must be periodically refreshed, such as, for example, dynamic RAM (DRAM) and non-volatile RAM, in which data is not periodically refreshed, such as, for example, static random access memory (SRAM). As described herein, main memory 764 may include, but is not limited to, DRAM, SRAM, synchronous DRAM (SDRAM), double data rate (DDR), SDRAM (DDR-SDRAM), Rambus DRAM (RDRAM) or any device capable of supporting high-speed temporary storage of data, including both volatile RAM and non-volatile RAM.

In one embodiment, chipset 760 may include integrated memory controller 765 for handling read and write access to main memory 764, as requested by the various agents coupled to chipset 760. However, in an alternate embodiment, a memory controller may be integrated within CPU 762 such that main memory 764 is coupled directly to CPU 762 via an interconnect. As described herein, an “agent” refers to any device or component coupled to chipset 760, which may arbitrate for ownership of an interconnect coupling the device to chipset 760 to request some system functionality, such as reading or writing to main memory 764.

Representatively, I/O controller 770 may control operations between processor 762 and one or more input/output (I/O) devices 775, for examples, a keyboard and a mouse over a low pin count (LPC) interconnect 771. The I/O controller 770 may also control operations between processor 762 and peripheral devices, for example, a drive 774 coupled to I/O controller 770 via an SATA interconnect 777. Additional interconnects may also be coupled to I/O controller 770 for controlling other devices, for examples, a peripheral component interconnect (PCI) bus 772, or follow on interconnect (e.g., PCIx, PCI Express) and a universal serial bus (USB) 776, or a follow on interconnect. In one embodiment, the memory controller 765 and the I/O controller 770 may be integrated into a single component.

In the embodiment illustrated, a driver controller 773 may be coupled to PCI bus 772 and may control operations of hard disk 774. In one embodiment, multiple device drivers 110 share access to drive controllers 773 and may be stored on the hard disk 774. Once loaded, disk drivers 110-1 and 110-2 may each desire to issue commands to hard disk 674. Accordingly, in one embodiment, driver controller 773 includes interface 200, to enable disk drivers 110-1 and 110-2 to share ownership of disk drive 774. In the embodiments described, disk drivers 110 may be assigned partial ownership of hard disk 774, thereby limiting disk drivers 110 to an assigned sub-range of the hard disk 774.

As further illustrated in FIG. 10, I/O controller 770 includes hardware interface 200. In one embodiment, hardware interface 700 enables multiple device drivers 110 to share access to I/O devices 775 and may be stored on hard disk drive 774. Accordingly, once loaded, I/O device drivers 110 may each desire to issue commands to I/O devices 775. Accordingly, in one embodiment, hardware interface 200 of I/O controller enables the I/O device drivers to share ownership of I/O devices 775. For example, in one embodiment, I/O controller 770 may include an audio host controller, including hardware interface 200, a system management bus host controller, including hardware interface 200, a USB host controller, including hardware interface 200, a LAN host controller, including hardware interface 200, a graphics host controller, including hardware interface 200, or other like controller, interconnect or device having hardware interface 200 to enable sharing of the hardware device between multiple software entities.

In one embodiment, multiple software drivers 110 may share access to an interconnect 772. To access interconnect 772, the software drivers 110 each issue a key request to hardware interface 200 of the interconnect 772. In response, a selected software entity receives a non-zero keyed semaphore and uses that keyed semaphore for atomic access of interconnect 772 for a predetermined period of time. Once the atomic access of interconnect 772 is complete, in one embodiment, the selected software entity relinquishes control of the hardware function by returning the keyed semaphore to hardware interface of interconnect 772 using, for example, key return logic 230, shown in FIG. 2.

BIOS memory 780 may be coupled to I/O controller 770 via interconnect 781. BIOS memory 780 is a non-volatile programmable memory, for example, a flash memory that retains the contents of data stored within it even after power is no longer supplied. Alternatively, BIOS memory 780 may be other types of programmable memory devices, for examples, a programmable read only memory (PROM) and an erasable programmable read only memory (EPROM). Computer system 700 may also include other BIOS memories in addition to BIOS memory 780.

Accordingly, one embodiment of the hardware interface described herein prohibits poorly-written software or malicious software from establishing ownership of a hardware function shared between multiple software entities. In one embodiment, failure of a software entity to relinquish an issued key within an allotted time may be used as an indication that the software entity is malfunctioning and thus provides additional security in the form of a watchdog timer for that software entity. Since the key is only known to the software entity currently assigned ownership of a hardware device or function, no other entity could attempt to make it appear that the software entity is still running.

Accordingly, in one embodiment, prohibiting a software entity from access to hardware function, unless the software entity can prove that the software entity has been granted control, prohibits malicious software from gaining access to a hardware function to perform undesired system activity. Furthermore, requiring a software entity to relinquish control of ownership awarded to a hardware function prohibits a malicious software entity from convincing a hardware function that the software entity is still running.

In a further embodiment, additional security may be provided by limiting software entities that share a hardware resource or function to an assigned sub-range of the hardware resource or function. In accordance with such an embodiment, the partial ownership of the hardware resource or function enables the software entity to issue commands or access the hardware resource or function so long as the access is limited to the sub-range of the hardware or resource or function assigned to the software entity. In one embodiment, partial ownership may be used, for example, to protect the integrity of a hardware resource or hardware function shared between multiple software entities.

For example, in one embodiment, a drive controller 773 (FIG. 10) might be owned by a legacy operating system (OS). However, since the legacy OS is limited to partial ownership of the drive controller 773, access to a hard disk 774 by the legacy OS is limited to the sub-range of the hard disk 774 allocated or assigned to the legacy OS. In accordance with such an embodiment, the legacy OS is prohibited from access to any portion of the hard disk that is owned by other software entities, such as a virtual machine or other like entity. In accordance with such an embodiment, ownership of the disk controller 773 may be awarded to the legacy OS, while at the same time, preventing a malicious agent, which might infect the legacy OS, such as a virus, from corrupting sectors on the hard disk 774 associated with other software entities running on the platform 700.

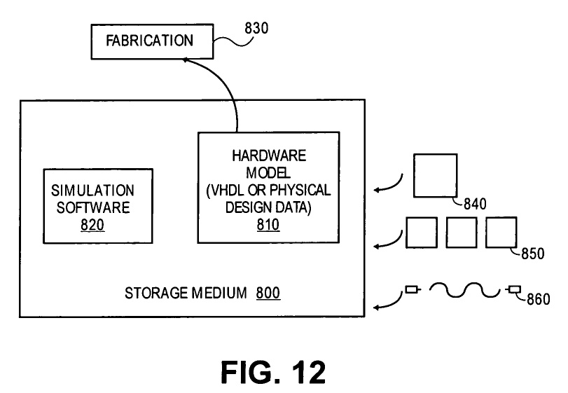

FIG. 12 is a block diagram illustrating various representations or formats for simulation, emulation and fabrication of a design using the disclosed techniques. Data representing a design may represent the design in a number of manners. First, as is useful in simulations, the hardware may be represented using a hardware description language, or another functional description language, which essentially provides a computerized model of how the designed hardware is expected to perform. The hardware model 810 may be stored in a storage medium 800, such as a computer memory, so that the model may be simulated using simulation software 820 that applies a particular test suite 830 to the hardware model to determine if it indeed functions as intended. In some embodiments, the simulation software is not recorded, captured or contained in the medium.

Additionally, a circuit level model with logic and/or transistor gates may be produced at some stages of the design process. The model may be similarly simulated some times by dedicated hardware simulators that form the model using programmable logic. This type of simulation taken a degree further may be an emulation technique. In any case, reconfigurable hardware is another embodiment that may involve a machine readable medium storing a model employing the disclosed techniques.

Furthermore, most designs at some stage reach a level of data representing the physical placements of various devices in the hardware model. In the case where conventional semiconductor fabrication techniques are used, the data representing the hardware model may be data specifying the presence or absence of various features on different mask layers or masks used to produce the integrated circuit. Again, this data representing the integrated circuit embodies the techniques disclosed in that the circuitry logic and the data can be simulated or fabricated to perform these techniques.

In any representation of the design, the data may be stored in any form of a machine readable medium. An optical or electrical wave 860 modulated or otherwise generated to transport such information, a memory 850 or a magnetic or optical storage 840, such as a disk, may be the machine readable medium. Any of these mediums may carry the design information. The term “carry” (e.g., a machine readable medium carrying information) thus covers information stored on a storage device or information encoded or modulated into or onto a carrier wave. The set of bits describing the design or a particular of the design are (when embodied in a machine readable medium, such as a carrier or storage medium) an article that may be sealed in and out of itself, or used by others for further design or fabrication.

### ALTERNATE EMBODIMENTS

It will be appreciated that, for other embodiments, a different system configuration may be used. For example, while the system 700 includes a single CPU 762, for other embodiments, a multiprocessor system (where one or more processors may be similar in configuration and operation to the CPU 762 described above) or a single CPU with multiple processor cores may benefit from the hardware interface 200 for shared access to a hardware resource/function of various embodiments. Further different type of system or different type of computer system such as, for example, a server, a workstation, a desktop computer system, a gaming system, an embedded computer system, a blade server, etc., may be used for other embodiments.

Elements of embodiments of the present invention may also be provided as a machine-readable medium for storing the machine-executable instructions. The machine-readable medium may include, but is not limited to, flash memory, optical disks, compact disks-read only memory (CD-ROM), digital versatile/video disks (DVD) ROM, random access memory (RAM), erasable programmable read-only memory (EPROM), electrically erasable programmable read-only memory (EEPROM), magnetic or optical cards, propagation media or other type of machine-readable media suitable for storing electronic instructions. For example, embodiments of the invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

It should be appreciated that reference throughout this specification to “one embodiment” or “an embodiment” means that a particular feature, structure or characteristic described in connection with the embodiment is included in at least one embodiment of the present invention. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the invention.

Similarly, it should be appreciated that in the foregoing description of embodiments of the invention, various features are sometimes grouped together in a single embodiment, figure, or description thereof for the purpose of streamlining the disclosure aiding in the understanding of one or more of the various inventive aspects. This method of disclosure, however, is not to be interpreted as reflecting an intention that the claimed subject matter requires more features than are expressly recited in each claim. Rather, as the following claims reflect, inventive aspects lie in less than all features of a single foregoing disclosed embodiment. Thus, the claims following the detailed description are hereby expressly incorporated into this detailed description, with each claim standing on its own as a separate embodiment of this invention.

What is claimed is:

1. An apparatus, comprising:
an interface to provide access to at least one hardware function, wherein access to the hardware function is shared between at least two software entities; and
access verification logic to deny an access request for the hardware function received from one of the at least two software entities unless a key associated with the access request matches a stored, keyed semaphore.

2. The apparatus of claim 1, wherein the interface further comprises:
decryption logic to decrypt received, encrypted commands issued to the hardware function using the stored, keyed semaphore if a key associated with the received, encrypted commands matches the stored, keyed semaphore.

3. The apparatus of claim 1, further comprising:
a random number generator to generate an N bit value as the keyed semaphore, where N is an integer greater than one; and
arbitration logic to provide the keyed semaphore to a selected software entity from the at least two software entities to grant temporary, exclusive access to the hardware functions.

4. The apparatus of claim 1, further comprising:
partial ownership logic, coupled to the access verification logic, the partial ownership logic to limit a software entity awarded partial ownership of the hardware function to a sub-range of the hardware function assigned to the software entity.

5. The apparatus of claim 1, wherein the access verification logic is to invalidate the stored, keyed semaphore after a predetermined period of time has elapsed from issuance of the keyed semaphore, such that subsequent access requests associated with an invalidated keyed semaphore as an operand are denied.

6. The apparatus of claim 1, wherein the verification logic is to receive the stored, keyed semaphore provided to the selected software entity once the selected software entity relinquishes ownership of the hardware function.

7. The apparatus of claim 1, wherein the interface is to receive a key request from a software entity of the at least two software entities to establish ownership of the hardware function, the interface to issue a stored, keyed semaphore to the software entity if ownership of the hardware function is currently available.

8. A method comprising:
receiving an access request for a hardware function, wherein access to the hardware function is shared between at least two software entities; and
denying the received access request unless a key associated with the access request matches a stored, keyed semaphore.

9. The method of claim 8, further comprising:
receiving a command issued to the hardware function from one of the at least two software entities, wherein the received command is encrypted using a key held by the software entity;
decrypting the received encrypted command using the stored keyed semaphore if a key associated with the received, encrypted commands matches the stored, keyed semaphore; and
issuing the decrypted command to the hardware function.

10. The method of claim 8, further comprising:
selecting a software entity from the at least two software entities to grant temporary exclusive access to the hardware function according to at least one received access request;
generating a keyed semaphore;
storing the keyed semaphore;
issuing the keyed semaphore to the selected software entity to indicate to the software entity that the software entity is granted temporary, exclusive access to the hardware function; and
issuing a predetermined value to a non-selected software entity to indicate to the non-selected software entity that an access request generated by the non-selected software entity is denied.

11. The method of claim 8, further comprising:
invalidating the stored keyed semaphore to form an invalid key if a predetermined period of time from issuance of the keyed semaphore has expired;
denying access requests having an associated key that matches the invalid key; and
issuing a new key to a software entity having ownership of the hardware function if an atomic exchange request is received from the software entity prior to expiration of the predetermined period of time from the issuance of the stored keyed semaphore.

12. The method of claim 8, further comprising:
receiving the keyed semaphore provided to the selected software entity to relinquish control of the hardware function;
generating a new keyed semaphore; and
storing the new keyed semaphore to issue the new keyed semaphore to grant ownership to the hardware function.

13. The method of claim 8, wherein prior to receiving the access request, the method further comprises:
receiving a key request from one of the at least software entities;
issuing the keyed semaphore to the software entity if ownership of the hardware function is currently available;
initiating a timer once the keyed semaphore is issued to the software entity;
invalidating the issued, keyed semaphore if the software entity does not relinquish control of the hardware function prior to expiration of the timer; and
resetting the timer if an atomic exchange request is received from the software entity.

14. An article of manufacture comprising:
a machine-accessible medium including data that, when accessed by a machine, cause the machine to perform operations comprising,
requesting a keyed semaphore to access a hardware resource shared between at least two software entities;
receiving access to the hardware resource if the keyed semaphore is a non-zero value; and
providing the keyed semaphore in combination with commands issued to the hardware function to access the hardware function.

15. The article of manufacture of claim 14, wherein the machine-accessible medium further includes data that cause the machine to perform operations comprising:
encrypting commands issued to the hardware function using the keyed semaphore.

16. The method of claim 14, wherein the machine-accessible medium further includes data that cause the machine to perform operations comprising:
providing the received key semaphore to an interface of the hardware function once access to the hardware function is complete to relinquish control of the hardware function.

17. A system comprising:
a first device driver;
a second device driver; and
a hardware device, the hardware device including an interface to provide access to at least one hardware function provided by the hardware device and access verification logic to deny an access request for the hardware function received from one of the first device driver and the second device driver, unless a key associated with the access request matches a stored, keyed semaphore, wherein access to the hardware function is shared between the first device driver and the second device driver.

18. The system of claim 17, wherein the interface further comprises:
decryption logic to decrypt received, encrypted commands issued to the hardware function by a device driver using the stored, keyed semaphore if a key associated with the received, encrypted commands matches the stored, keyed semaphore.

19. The system of claim 17, wherein the hardware device further comprises:
a random number generator to generate an N bit value as the keyed semaphore, where N is an integer greater than one; and
arbitration logic to provide the keyed semaphore to a selected device driver from the first and second device drivers to grant temporary, exclusive access to the hardware function provided by the hardware device.

20. The system of claim 17, wherein the hardware device is one of a bus and a hard disk.

21. The system of claim 17, wherein the hardware device further comprises:
partial ownership logic, coupled to the interface, the partial ownership interface to limit a software entity awarded partial ownership of the hardware device to a sub-range of the hardware device assigned to the software entity.

22. A method comprising:
receiving an access request for a hardware function, wherein the access request is received from a software entity of at least two software entities that share ownership of the hardware function;
determining a type of ownership of the hardware function assigned to the software entity if a key associated with the access request matches a stored keyed semaphore;
granting the received access request if the type of ownership of the hardware function assigned to the software entity is exclusive ownership; and
denying the received access request if the type of ownership assigned to the software entity is partial ownership and the access request falls outside a sub-range of the hardware function assigned to the software entity.

23. The method of claim 22, wherein the method further comprises:
granting the access request if the type of ownership assigned to the software entity is partial ownership and the access request falls within a sub-range assigned to the software entity.

24. The method of claim 22, wherein the at least two software entities comprise disk drivers, the hardware function comprises a hard disk and the disk drivers are assigned partial ownership of the hard disk, such that each disk driver is limited to a predetermined number of sectors of the hard disk.
